(19) United States
(12) Patent Application Publication
(10) Pub. No.: US 2019/0375863 A1
(43) Pub. Date: Dec. 12, 2019

(54) A PROCESS FOR REMOVING CHLORIDE FROM A POLYMER MELT

(71) Applicant: Reliance Industries Limited, Mumbai (IN)

(72) Inventors: Vijayalakshmi Ravi Puranik, Vadodara (IN); Kalpeshkumar Bhikhubhai Sidhpuria, Surat (IN)

(73) Assignee: Reliance Industries Limited, Mumbai (IN)

(21) Appl. No.: 16/481,260

(22) PCT Filed: Jan. 6, 2018
(86) PCT No.: PCT/IB2018/050093

§ 371 Date: Jul. 26, 2019

(30) Foreign Application Priority Data
Feb. 3, 2017 (IN) 201721004094

(51) Int. Cl. C08F 6/28; C08F 6/02; C08F 10/02; C08F 10/06; B01D 15/02

(52) U.S. Cl. CPC C08F 6/28; C08F 6/02; C08F 10/02; B01D 2253/1124; B01D 15/02; B01D 2253/108; B01D 2253/104; C08F 10/06

(57) ABSTRACT

The present disclosure provides a process for removing chloride from a polymer melt using at least one adsorbent. The adsorbent is selected from a metal oxide mixture, a mixture of alumina and hydrotalcite, crystalline fajausite zeolite and alumina doped with at least one metal. The process of the present disclosure is carried out at a temperature in the range of 260° C. to 280° C., and at a pressure in the range of 120 bar to 160 bar for time period in the range of 12 hours to 200 hours. The amount of chloride adsorbed on the adsorbent is in the range of 0.1% to 6.0% w/w.

### FIELD

The present disclosure relates to a process for removing chloride from a polymer melt.

### BACKGROUND

Polymerization of olefin can be carried out in the presence of metal chlorides as catalysts. Typically, for the polymerization of olefin, titanium tetrachloride (TiCl₄) and vanadium oxychloride (VOCl₃) are used as catalysts along with aluminum-based co-catalyst such as triethylaluminum (TEAL), diethylaluminum (DEAL), and diethyl aluminium ethoxide (DEAEO).

The polymer melt obtained upon completion of the polymerization step has high chloride content. The post-polymerization work-up involves removal of chloride, along with the removal of Vanadium (V), Titanium (Ti), and Aluminum (Al) from the polymer melt to obtain the polyolefin.

Typically, chlorides are removed first, followed by the removal of metal component, polymer from melt, and fluid medium which can be recovered and reused for polymerization. Therefore, it is necessary that the adsorbent used for the removal of chlorides has high selectivity for chloride removal.

Conventionally, alumina coated with an alkali metal is employed as an adsorbent in the process for removing chloride and metal component from the polymer melt. The alkali metal neutralizes chloride and thereby reduces the chloride content of the polymer melt Alkali metal chlorides such as sodium chloride (NaCl) formed by neutralization form dust. Further, the use of adsorbent bed containing alumina coated with an alkali metal as adsorbent leads to a high pressure drop across the adsorbent bed during this process. Due to these problems, the adsorbent bed containing alumina needs to be replaced before full utilization of its adsorbent capacity leading requirement of higher amounts of alumina, high amount of downtime of apparatus due to tedious replacement process, disposal of larger amounts of used alumina, and overall high costs of operation.

Therefore, there is felt a need for a process to efficiently remove chloride from a polymer melt before the polymer melt is subjected to removal of V, Ti, and Al. It is desirable that the process for removing chloride from the polymer melt does not significantly reduce the content of Ti and V in the polymer melt.

### Objects

Some of the objects of the present disclosure, which at least one embodiment herein satisfies, are as follows.

It is an object of the present disclosure to ameliorate one or more problems of the prior art or to at least provide a useful alternative.

An object of the present disclosure is to provide an efficient process for removing chloride from a polymer melt.

Other objects and advantages of the present disclosure will be more apparent from the following description, which is not intended to limit the scope of the present disclosure.

### SUMMARY

In an aspect, the present disclosure provides a process for removing chloride from a polymer melt using at least one adsorbent. The process of the present disclosure comprises the following steps:

The polymer melt containing chlorides is dissolved in at least one fluid medium to from a polymer melt solution.

Typically, the fluid medium is selected from the group consisting of cyclohexane, and normal paraffin fluids.

The polymer melt and the fluid medium are mixed in a predetermined weight ratio to from the polymer melt solution. The amount of polymer melt in the polymer melt solution is in the range of 10% w/w to 30% w/w.

In accordance with one embodiment of the present disclosure, the amount of polymer melt in the polymer melt solution is 18% w/w.

The chlorides are extracted from the polymer melt solution by adsorbing chlorides on at least one adsorbent at a predetermined temperature to obtain a resultant mixture containing treated polymer melt solution and adsorbent with adsorbed chloride.

The adsorbent with adsorbed chloride is separated from the resultant mixture to obtain a treated polymer melt solution with reduced chloride content.

The process of the present disclosure further involves a step of separating the fluid medium from the treated polymer melt solution with reduced chloride content. The separation is carried out by evaporation of the fluid medium under reduced pressure.

The polymer melt is at least one selected from the group consisting of polyethylene melt, and polypropylene melt.

In accordance with one embodiment of the present disclosure, the adsorbent comprises metal oxide mixture and a binder. The metal oxide mixture containing at least one metal oxides selected from the group consisting of zinc oxide, calcium oxide, magnesium oxide, and aluminum oxide.

In accordance with another embodiment of the present disclosure, the adsorbent is a mixture of alumina and hydrotalcite.

In accordance with yet another embodiment of the present disclosure, the adsorbent is fajausite crystalline zeolite.

In accordance with yet another embodiment of the present disclosure, the adsorbent is alumina doped with at least one alkaline earth metal selected from the group consisting of lithium, sodium, potassium, cesium, and rubidium, typically sodium.

The amount of the polymer melt in the polymer melt solution is in the range of 5 weight % to 25 weight %

The weight ratio of the adsorbent to the polymer melt is in the range of 1:1000 to 20:1000.

The predetermined temperature at which the step of contacting is carried out is in the range of 200° C. to 300° C.

The step of extracting chlorides from the polymer melt solution is carried out at a pressure is in the range of 120 bar to 160 bar.

The step of extracting chlorides from the polymer melt solution is carried out for a time period in the range of 12 hours to 200 hours.

In accordance with the embodiments of the present disclosure, the reduction in the chloride content of the polymer melt is in the range of 0.1% to 6.0% w/w.

### DETAILED DESCRIPTION

Polymerization of olefins can be carried out in the presence of metal chlorides as catalysts. The polymer melt obtained after polymerization has high chloride content. Conventionally, an adsorbent bed containing alumina coated with alkali metal is employed in the process for removing chloride from the polymer melt. However, chloride is removed from the polymer melt by neutralization, and resultant alkali metal chloride leads to problems such as dust formation. Further, the adsorbent bed containing alumina leads to high pressure drop across the adsorbent bed during this process. The present disclosure envisages a process to efficiently remove chloride from a polymer melt before the polymer melt is subjected to removal of V, Ti, and Al. Further, the process for removing chloride from the polymer melt does not significantly reduce the content of Ti and V in the polymer melt.

In an aspect, the present disclosure provides a process for removing chloride from a polymer melt using at least one adsorbent. The process of the present disclosure comprises the following steps:

The polymer melt is dissolved in at least one fluid medium to from a polymer melt solution.

The fluid medium is selected from the group consisting of cyclohexane, and normal paraffin fluids. Typically, the fluid medium is cyclohexane.

The polymer melt and the fluid medium are mixed in a predetermined weight ratio to obtain the polymer melt solution. The amount of the polymer melt in the polymer melt solution is in the range of 5 weight % to 25 weight %.

The chlorides are extracted from the polymer melt solution by absorbing chlorides on at least one adsorbent at a predetermined temperature to obtain a resultant mixture containing treated polymer melt solution and adsorbent with adsorbed chloride.

The polymer melt solution and the adsorbent are mixed in a predetermined weight ratio in the step of contacting. The weight ratio of the adsorbent to the polymer melt is in the range of 1:1000 to 20:1000.

The adsorbent with adsorbed chloride is separated from the resultant mixture to obtain a treated polymer melt solution with reduced chloride content.

In accordance with one embodiment of the present disclosure, the treated polymer melt solution is directly taken to the next step without separation of the fluid medium.

Optionally, the process of the present disclosure further involves a step of separating the fluid medium from the treated polymer melt solution with reduced chloride content. The separation is carried out by evaporation of the fluid medium under reduced pressure.

The polymer melt is at least one selected from the group consisting of polyethylene melt, and polypropylene melt, typically, the polymer melt is polyethylene melt.

In accordance with one embodiment of the present disclosure, the adsorbent comprises a metal oxide mixture and a binder. The metal oxide mixture comprises metal oxides selected from the group consisting of zinc oxide, calcium oxide, magnesium oxide, and aluminum oxide.

In accordance with an exemplary embodiment of the present disclosure, the metal oxide mixture comprises zinc oxide and calcium oxide.

In accordance with another embodiment of the present disclosure, the adsorbent is a mixture of alumina and hydrotalcite.

In accordance with yet another embodiment of the present disclosure, the adsorbent is fajausite crystalline zeolite.

In accordance with yet another embodiment of the present disclosure, the adsorbent is alumina doped with at least one alkaline earth metal selected from the group consisting of lithium, sodium, potassium, cesium, and rubidium, typically, the adsorbent is alumina is doped with sodium.

The predetermined temperature at which the step of contacting is carried out is in the range of 200° C. to 300° C., preferably 260° C. to 280° C.

The step of extracting chlorides from the polymer melt solution is carried out at a pressure is in the range of 120 bar to 160 bar. The step of extracting chlorides from the polymer melt solution is carried out for a time period in the range of 12 hours to 200 hours.

In accordance with the embodiments of the present disclosure, the amount of chloride adsorbed by the adsorbent is in the range of 0.1% to 6.0% w/w. Therefore, the process of the present disclosure is capable of efficiently removing chloride from a polymer melt.

In accordance with the embodiments of the present disclosure, the amount of titanium adsorbed on the adsorbent is in the range of 0.01 to 1.05% w/w. The amount of vanadium adsorbed on the adsorbent is in the range of 0.12 to 0.96% w/w. Therefore, the process of the present application does not significantly reduce the content of Ti and V in the polymer melt.

The disclosure will now be described with reference to the laboratory experiments, which do not limit the scope and ambit of the disclosure. The description provided is purely by way of example and illustration.

The laboratory scale experiments provided herein can be scaled up to industrial or commercial scale.

### EXAMPLES

### Example 1

Mixed metal oxide containing 33% zinc oxide (ZnO), 19% calcium oxide (CaO), and 48% alimina was used as adsorbent in Example 1. The mixed metal oxide was in the form of cylindrical extrudates having a diameter of 1.5 mm and length of 5 mm The surface area was 34 m²/g, bulk density was 820 kg/m³, and pore volume was 0.1 cc/g.

100 g of the mixed metal oxide adsorbent mentioned above was kept in contact with a polymer melt solution comprising polyethylene polymer melt and cyclohexane at 270° C. and 140 bar for 72 hours in a reactor. The amount of polyethylene melt in the polymer melt solution was 18% w/w. Initial chloride content of the polyethylene melt was 72.4 g per ton of polyethylene melt. The polymer melt solution was contacted with the adsorbent at the rate of 165 ton/h.

The adsorbent with adsorbed chloride was separated and was analyzed for adsorption of various metals and non-metals by the adsorbent.

### EDAX (Energy Dispersive X-Ray Analysis (EDX))

Surface analysis: Chloride: 5.4% w/w; Al: 0.5% w/w

Bulk analysis: Chloride: 3.3% w/w, V: 0.12% w/w, Ti: 0.01% w/w, Al: 0.65% w/w

The mixed metal oxide adsorbent showed high capacity for adsorbing chloride and aluminum.

### Example 2

Hydrotalcite mixed with alumina was used as adsorbent in Example 2. The adsorbent was in the form of cylindrical extrudates having a diameter of 1.5 mm and length of 5 mm The adsorbent had a surface area of 290 m²/g, bulk density of 350 kg/m³, and pore volume of 0.53 cc/g.

100 g of the hydrotalcite mixed with alumina adsorbent mentioned herein above was kept in contact with a polymer melt solution comprising polyethylene melt in cyclohexane at 270° C. and 140 bar for 72 hours in a reactor. The amount of polyethylene melt in the polymer melt solution was 18% w/w. Initial chloride content of the polyethylene melt was 72.4 g per ton of polyethylene melt. The polymer melt solution was contacted with the adsorbent at the rate of 165 ton/h.

The adsorbent with adsorbed chloride was separated and was analyzed for adsorption of various metals and non-metals:

EDAX Surface analysis: Chloride: 3.1% w/w, V: 0.96% w/w, Ti: 0.35% w/w

Bulk analysis: Chloride: 1.95% w/w, V: 0.36% w/w, Ti: 0.12% w/w, Al: nil

The adsorbent based on hydrotalcite mixed with alumina showed high capacity for adsorbing chloride.

### Example 3

Mixed sodium form of faujasite crystalline zeolite was used as an adsorbent in Example-3. The adsorbent was spherical in shape having a diameter of 3 mm The adsorbent had a surface area of 543 m²/g, bulk density of 700 kg/m³, and pore volume of 0.31 cc/g.

100 g of mixed sodium form of faujasite crystalline zeolite mentioned herein above was kept in contact with a polymer melt solution of polyethylene melt and cyclohexane at 270° C. and 140 bar for 72 hours in a reactor. The amount of polyethylene melt in the polymer melt solution was 18% w/w. Initial chloride content of the polyethylene melt was 72.4 g per ton of polyethylene melt. The polymer melt solution was contacted with the adsorbent at the rate of 165 ton/h.

The adsorbent with adsorbed chloride was separated and the adsorbent was analyzed for adsorption of various metals and non-metals:

EDAX Surface analysis: Chloride: 3.09% w/w; Ti: 1.05% w/w

Bulk analysis: Chloride: 1.32% w/w, V: 0.29% w/w, Ti: 0.13% w/w, Al: nil

The adsorbent based on faujasite crystalline zeolite showed high capacity for adsorbing chloride.

### Example 4

Alumina doped with 2% sodium adsorbent was used in Example 4. The adsorbent was in the form of cylindrical beads having a diameter of 3 mm. The adsorbent had a surface area of 260 m²/g, and bulk density of 800 kg/m³.

100 g alumina doped with 2% soda adsorbent mentioned herein above was kept in contact with a polymer melt solution comprising the polyethylene melt and cyclohexane containing residual catalyst at 270° C. and 140 bar for 72 hours in a reactor. The amount of polyethylene melt in the polymer melt solution was 18% w/w. Initial chloride content of the polyethylene melt was 72.4 g per ton of polyethylene melt. The polymer melt solution was contacted with the adsorbent at the rate of 165 ton/h.

The adsorbent with adsorbed chloride was separated and the adsorbent was analyzed for adsorption of various metals and non-metals:

EDAX Surface analysis: Chloride: 2.5% w/w Ti: 0.63% w/w

Bulk analysis: Chloride: 1.81% w/w, V: 0.89% w/w, Ti: 0.32% w/w, Al: Nil

The alumina doped with 2% sodium adsorbent showed high capacity for adsorbing chloride.

### Technical Advances and Economic Significance

The present disclosure described herein above has several technical advantages including, but not limited to, the realization of:
an efficient process for removing chloride from a polymer melt; and
a process for removing chlorides from a polymer melt that does not significantly reduce the content of Ti and V in the polymer melt.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A process for removing chloride from a polymer melt using at least one adsorbent, the process comprising the following steps:
dissolving the polymer melt containing chlorides with at least one fluid medium to form a polymer melt solution;
extracting the chlorides from the polymer melt solution by adsorbing chlorides on at least one adsorbent that is contacted with the polymer melt solution at a predetermined temperature to obtain a resultant mixture containing treated polymer melt solution and adsorbent with adsorbed chloride; and
separating the adsorbent with adsorbed chloride from the resultant mixture to obtain a polymer melt solution with reduced chloride content.

2. The process as claimed in claim 1, further involves the step of separating the fluid medium from the polymer melt solution with reduced chloride content, wherein the separation is carried out by evaporation of the fluid medium under reduced pressure.

3. The process as claimed in claim 1, wherein the polymer melt is at least one selected from the group consisting of polyethylene melt, and polypropylene melt.

4. The process as claimed in claim 1, wherein the adsorbent comprises a metal oxide mixture and a binder, the metal oxide mixture comprises metal oxides selected from the group consisting of zinc oxide, calcium oxide, magnesium oxide, and aluminum oxide.

5. The process as claimed in claim 1, wherein the adsorbent is a mixture of alumina and hydrotalcite.

6. The process as claimed in claim 1, wherein the adsorbent is crystalline fajausite zeolite.

7. The process as claimed in claim 1, wherein the adsorbent is alumina doped with at least one alkaline earth metal selected from the group consisting of lithium, sodium, potassium, cesium, and rubidium.

8. The process as claimed in claim 1, wherein the amount of the polymer melt in the polymer melt solution is in the range of 5 weight % to 25 weight %.

9. The process as claimed in claim 1, wherein the weight ratio of the adsorbent to the polymer melt is in the range of 1:1000 to 20:1000.

10. The process as claimed in claim 1, wherein the fluid medium is selected from the group consisting of cyclohexane, and normal paraffin fluids.

11. The process as claimed in claim 1, wherein the predetermined temperature is in the range of 200° C. to 300° C.

12. The process as claimed in claim 1, wherein the step of extracting chlorides from the polymer melt solution is carried out at a pressure is in the range of 120 bar to 160 bar.

13. The process as claimed in claim 1, wherein the step of contacting is carried out for a time period in the range of 12 hours to 200 hours.

14. The process as claimed in claim 1, wherein the amount of chloride adsorbed by the adsorbent is in the range of 0.1% to 6.0% w/w.
